(19) United States
(12) Patent Application Publication
(10) Pub. No.: US 2008/0126629 A1
(43) Pub. Date: May 29, 2008

(54) METHOD OF WAKE-UP SCAN FOR KVM SWITCH

(75) Inventor: Shih-yuan Huang, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/463,991

(22) Filed: Aug. 11, 2006

(51) Int. Cl. G06F 13/12

(52) U.S. Cl. 710/64

(57) ABSTRACT

A method of wake-up scan for a keyboard-video-mouse (KVM) switch is disclosed. The method of wake-up scan includes steps (a) to (d). The step (a) is switching to a target computer. The step (b) is sending a simulated keyboard and/or mouse signal to the target computer for waking up the target computer. The step (c) is transmitting a video signal of the target computer to a console display and the step (d) is returning to step (a) until a termination command is received. The KVM switch includes a switching mechanism for switching to the least one target computer. The switching mechanism can includes a first switching device for video signal and a second switching device for keyboard and/or mouse signal. Alternatively, the switching mechanism includes a crosspoint switch to transmit the video signal, to detect the video signal and to send the simulated keyboard and/or mouse signal simultaneously.

### FIELD OF THE INVENTION

The present invention generally relates to a method of wake-up scan, and more particularly to a method of implementing wake-up scan of a keyboard-video-mouse (KVM) switch for a plurality of computers coupled thereto.

### BACKGROUND OF THE INVENTION

Nowadays, most of keyboard-video-mouse (KVM) switch are provided with scan functions for an administrator when he is monitoring all the computers coupled with the KVM switch. For example, an Auto-Scan function is an operation mode automatically switching the computers sequentially to show real-time images of the computers on a display of a console for the administrator. Accordingly, the administrator can monitor all the computers' status without manual operation to switch the computers to show the real-time images one by one. Some KVM switches are further provided with a Programmable-Scan Function or a Quick View-Scan Function to give the administrator more power to execute the scan operation to the computers.

The Programmable-Scan Function or Quick View-Scan is an operation mode not only to switching the computers sequentially to show the real-time images on the display automatically, but also to pre-set the time interval or to list only the selected computers to be scanned. Therefore, the administrator can predetermine the desired scan condition to achieve a proper operation mode of the KVM switch for monitoring the computers coupled thereto. However, All conventional scan functions have drawbacks without considering that modern computers may usually enter power saving mode or sleeping mode in which no video signal will be output for energy saving and display protection. The KVM switch cannot receive video signals from a computer coupled thereto when the computer is in power saving mode or sleeping mode. All aforesaid scan functions will result in showing no image on the display when the KVM switches to the computer in power saving mode or sleeping mode.

Accordingly, it is meaningless monitoring blank screens provided by the aforesaid scan functions for the administrator. Consequently, there is a need to develop a method for waking up the computers to be scanned, i.e., wake-up scan, for a keyboard-video-mouse (KVM) switch to monitor real-time images of all the power-on computers.

### SUMMARY OF THE INVENTION

To solve the foregoing drawbacks in the prior art, it is an objective of the present invention is to provide a method of wake-up scan for a keyboard-video-mouse (KVM) switch to monitor real-time images of all the power-on computers coupled thereto via connecting ports intervally or periodically. The method of wake-up scan includes the following steps (a) to (d) for accomplishing the above objective.

The step (a) is switching to at least one target computer. The step (b) is sending at least one simulated keyboard and/or mouse signal generated by the KVM switch to the target computer for waking up the target computer. The step (c) is transmitting a video signal of the target computer to at least one console display and the step (d) is returning to step (a) until an termination is received. If one connecting port is null or the computer coupled with is powered off, the method of wake-up scan skips the step (b) and the step (c) by jumping from the step (a) to the step (d) because no computer signals of the target computer are detected at the null connecting port. If the target computers are awakened, the method of wake-up scan skips the step (b) by jumping from the step (a) to the step (c) because the video signal of the target computer is detected and can be transmitted to the console display. In step (a), the target computers are switched based on a predetermined order, which can be set via an on-screen display menu generated by the KVM switch.

The video signal can be a VGA signal, a DVI signal or a HDMI signal. More precisely speaking, the detected VGA signal is at least one of R-signal, G-signal, B-signal, H-Sync signal and V-sync signal included in the VGA signal. The detected DVI signal and the detected HDMI signal is the EDID data transmitted in a DDC channel, which is being employed.

The keyboard-video-mouse (KVM) switch with wake-up scan function according to the present invention includes a switching mechanism, a keyboard/mouse controller and a micro control unit. The switching mechanism switches to at least one target computer. The keyboard/mouse controller generates a simulated keyboard/mouse signal. The micro control unit detects computer signals and video signal of the target computer and sends at least one simulated keyboard and/or mouse signal to the target computer for waking up the target computer.

The switching mechanism may include a first switching device and a second switching device such that the video signal of a first target computer may be transmitted to the console display while the simulated keyboard and/or mouse signal is being sent to a second target computer concurrently. Alternatively, the switching mechanism may include a crosspoint switch to transmit the video signal of a first target computer to the console display, to detect the video signal of a second target computer and to send the simulated keyboard and/or mouse signal to a third target computer via the crosspoint switch simultaneously.

Accordingly, the method of wake-up scan for the KVM switch according to the present invention may monitor the real-time images of all the power-on computers coupled thereto via connecting ports intervally or periodically by a predetermined order and an termination condition of the wake-up scan function that both can be set via the on-screen display menu.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a functional block diagram of a keyboard-video-mouse (KVM) switch having wake-up scan function according to first embodiment of the present invention;

FIG. 2 illustrates a functional block diagram of a keyboard-video-mouse (KVM) switch having wake-up scan function according to the second embodiment of the present invention;

FIG. 3 illustrates a functional block diagram of a keyboard-video-mouse (KVM) switch having wake-up scan function according to the third embodiment of the present invention; and

FIG. 4 shows a flow chart of the method of wake-up scan for a keyboard-video-mouse (KVM) switch of the present invention.

### DETAILED DESCRIPTION OF THE PREFERRED EMBODIMENTS

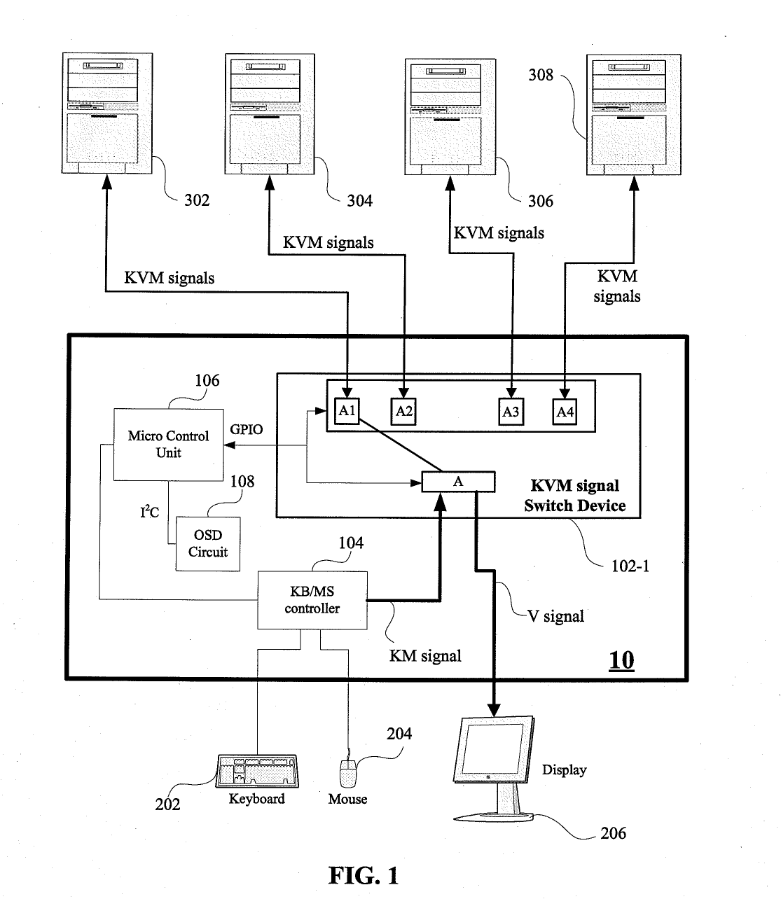

Please refer to FIG. 1, which illustrates a functional block diagram of a keyboard-video-mouse (KVM) switch 10 having wake-up scan function according to first embodiment of the present invention. In the first embodiment, the KVM switch 10 is coupled with a keyboard 202, a mouse 204 and a display 206 as a console, and coupled with computers 302, 304, 306 and 308. The number of computers coupled with the KVM 10 is not limited but depends on the capability of the KVM switch 10. The number of computers coupled with some KVM switch may be up to sixteen or even thirty-two. The KVM witch 10 includes at least a switching mechanism 102-1, a keyboard/mouse controller 104 and a micro control unit 106. The switching mechanism 102-1 is employed to switch the keyboard, video and mouse signals between the console and the computers 302, 304, 306 and 308. The keyboard/mouse controller 104 is coupled with the keyboard 202 and mouse 204 to receive the keyboard/mouse signal or can be employed to generate simulated keyboard/mouse signals according to a command of the micro control unit 106. The micro control unit 106 can detect computer signals and video signals from one of the computers 302, 304, 306 and 308 and send the simulated keyboard and/or mouse signals to the computers 302, 304, 306 and 308 for waking them up from power saving mode or sleeping mode.

Specifically, the switching mechanism 102-1 receives a keyboard signal and a mouse signal from the keyboard/mouse controller 104 through a connecting port A and transmits to one of the computers 302, 304, 306 and 308 through connecting ports A1, A2, A3 or A4 respectively. Moreover, the switching mechanism 102-1 receives video signals from one of the computers 302, 304, 306 and 308 through the respective connecting ports A1, A2, A3 or A4 and transmits the video signals to the display 206 through the connecting port A. The switching mechanism 102-1 can provide one route between the connecting port A and the connecting ports A1, A2, A3 and A4, i.e. between the console (keyboard 202, mouse 204, display 206) and one of the computers 302, 304, 306 and 308 for transmitting the keyboard and mouse signals from the connecting port A to one of the connecting ports A1, A2, A3 and A4 while receiving the video signals from one of the connecting ports A1, A2, A3 and A4 to the connecting port A at the same time.

When an administrator triggers the wake-up scan function of the KVM switch 10 for monitoring the computers 302, 304, 306 and 308 in a predetermined order (such as 302-304-306-308), the switching mechanism 102-1 switches to the computer 302 through the connecting port A1. The micro control unit 106 can detect the computer signals (typically a power signal of 5-volt DC in PS/2 or USB standard for transmitting the keyboard signals and the mouse signals) and the video signals from the computer 302 through GPIO (General Purpose Input and Output) lines connecting to the ports A, A1, A2, A3 and A4, and meanwhile can control the switching mechanism 102-1.

If the connecting port is null, i.e., no computer is coupled with, such that no computer signals are detected, the switching mechanism 102-1 will switch to the next port, the port A2, to detect the computer signals and the video signals of the computer 304.

If both the computer signals and the video signals from the computer 304 are detected, the switching mechanism 102-1 will transmit the video signals of the computer 304 to the display 206 and then switch to the next port, the port A3, to detect the computer signals and the video signal of the computer 306.

If the computer signals of the computer 306 are detected but the video signals of computer 306 is not, the micro control unit 106 will give an order to the keyboard/mouse controller 106 to generate simulated keyboard and/or mouse signals and send to the computer 306 for waking it up, such that the video signals of the computer 306 would then be available to be transmitted to the display 206. Then switching to the next port, the port A4, for detecting the computer signals and the video signals of the computer 308.

If both the computer signals and the video signals from the computer 308 are detected, the switching mechanism 102-1 will transmit the video signals of the computer 308 to the display 206 to complete the first loop of the wake-up scan.

The way of detecting the video signals from the computers 302, 304, 306 and 308 depends on the video standard applied in the KVM switch 10. The general video standards in such field are such as VGA (Video Graphics Array) standard, DVI (Digital Video Interactive) standard and HDMI (High Definition Multimedia Interface) standard. If the VGA standard is employed in the KVM switch 10, one may choose to detect one of the R, G, B signals for confirming whether the computer is awakened or sleeping. Alternatively, one may also choose to detect the H-Sync signal or the V-sync signal for confirming the same thing. If the DVI or the HDMI standard is employed, one may detect an EDID data transmitted in a DDC channel for confirming the active status of the computer, as aforementioned, awakened or sleeping.

Furthermore, the wake-up scan process may be terminated by a predetermined condition, such as, exceeding a predetermined period of time for wake-up scanning, exceeding a predetermined number of loops of wake-up scanning, and receiving a termination command from the administrator (user). Moreover, the aforesaid predetermined order of scanning and the aforesaid termination condition may be set up via an on-screen display (OSD) menu generated by an on-screen display (OSD) circuit 108 of the KVM switch 10.

According to the present invention, drawbacks of prior arts can be solved; therefore, any computer (anyone of the computers 302, 304, 306 and 308) in a green energy saving mode or a sleeping mode will be awakened before its being scanned so that the KVM switch 10 can transmit the video signal thereof to the display 206. The wake-up scan of present invention makes sure that all real-time images of the power-on computers coupled with the KVM switch 10 can be monitored, shown on the display 206 for the administrator.

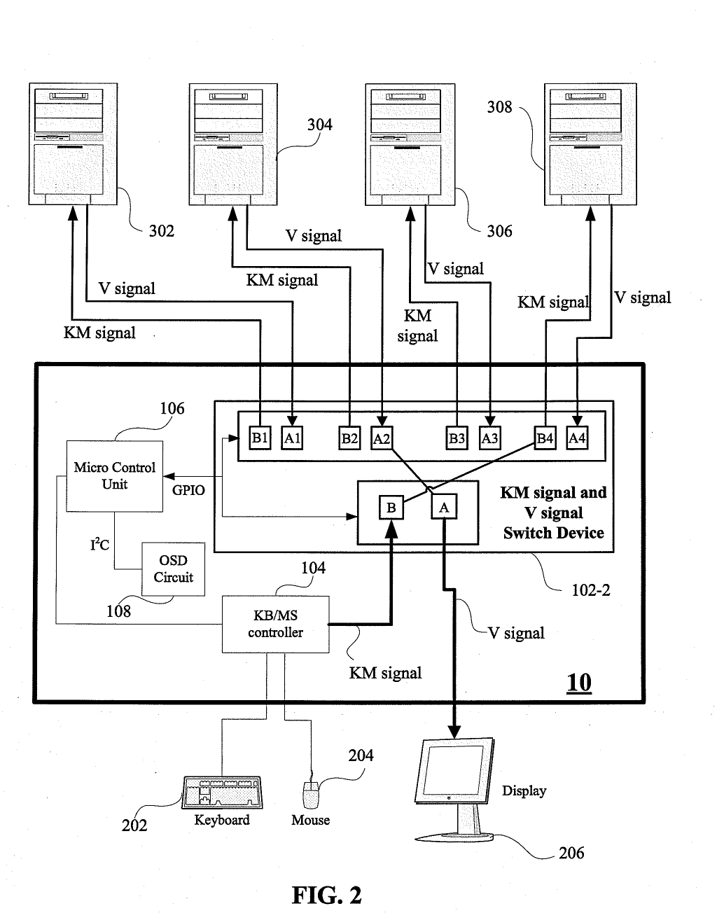

Please refer to FIG. 2, which illustrates a functional block diagram of a keyboard-video-mouse (KVM) switch having wake-up scan function according to the second embodiment of the present invention. In the second embodiment, a switching mechanism 102-2 is employed to switch the keyboard, video and mouse signals between the console and the computers 302, 304, 306 and 308. The switching mechanism 102-2 comprises a first switching device for the video signal and a second switching device for the keyboard and/or mouse signals. The first switching device comprises a port A coupling with the display 206, and ports A1, A2, A3 and A4 coupling with the video outputs of the computers 302, 304, 306 and 308 respectively. And meanwhile, the second switching device comprises a port B coupling with the keyboard/mouse controller 104, and ports B1, B2, B3 and B4 coupling with the keyboard/mouse inputs of the computers 302, 304, 306 and 308 respectively. By separating the video signal routes and the keyboard/mouse signal routes, the video signal of one of the computers 302, 304, 306 and 308, say computer 304 as illustrated in FIG. 2, may be transmitted to the display 206 for monitoring while in the background, the micro control unit 106 may detect the presence the computer signals or the video signal of another of the computers 302, 304, 306 and 308, say computer 308 as illustrated in FIG. 2, and the keyboard/mouse controller 104 may send the simulated keyboard and/or mouse signals to the computer 308 if it is in power saving mode or sleeping mode.

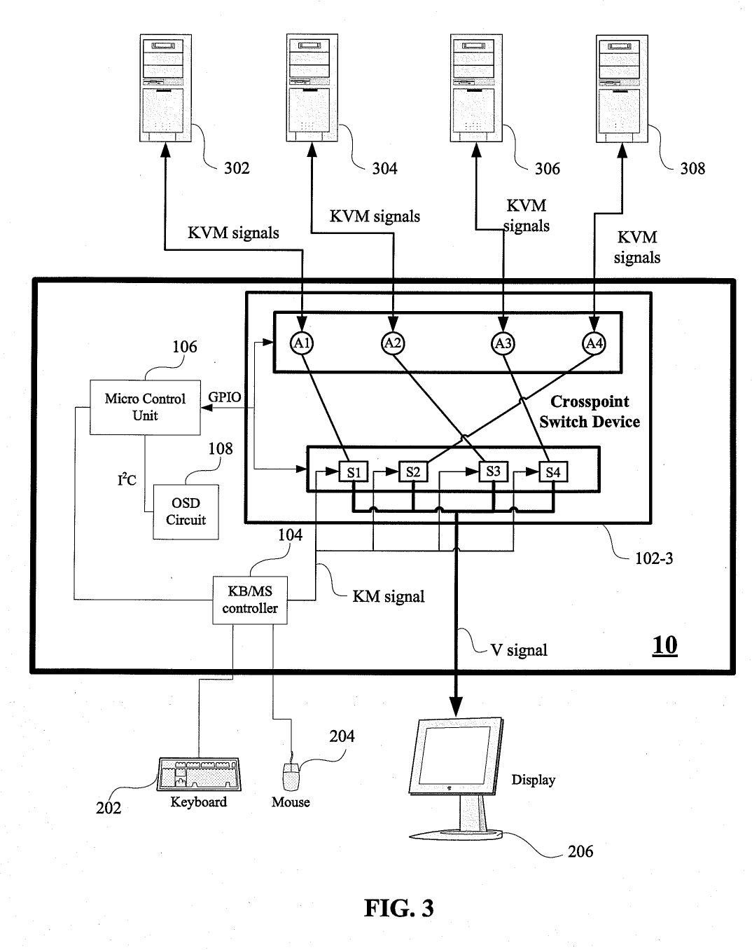

Please refer to FIG. 3, which illustrates a functional block diagram of a keyboard-video-mouse (KVM) switch having wake-up scan function according to the third embodiment of the present invention. In the third embodiment, a switching mechanism 102-3 is employed to switch the keyboard, video and mouse signals between the console and the computers 302, 304, 306 and 308. The switching mechanism 102-3 comprises a crosspoint switch. The crosspoint switch has ports S1, S2, S3 and S4 for keyboard-video-mouse signals of the keyboard 202, the mouse 204 and the display 206, and ports A1, A2, A3 and A4 for coupling with the keyboard-video-mouse signals of the computers 302, 304, 306 and 308 respectively. By providing multi-routes between the console (the keyboard 202, the mouse 204 and the display 206) and the computers 302, 304, 306 and 308, the micro control unit 106 may do three things at the same time: detecting the computer signals or the video signal of the computers 302, 304, 306 and 308; transmitting the video signal of another of the computers 302, 304, 306 and 308 to the display 206 for monitoring; and sending the simulated keyboard and/or mouse signals to yet another of the computers 302, 304, 306 and 308 for waking it up if it is in power saving mode or sleeping mode.

For example, if the order of the wake-up scan for the computers is 308-306-304-302, the KVM switch 10 may transmit the video signal of the computer 308 while the simulated keyboard and/or mouse signals are being sent to the computer 306 for waking it up and the computer signals or the video signal of the computer 304 is being checked for presence.

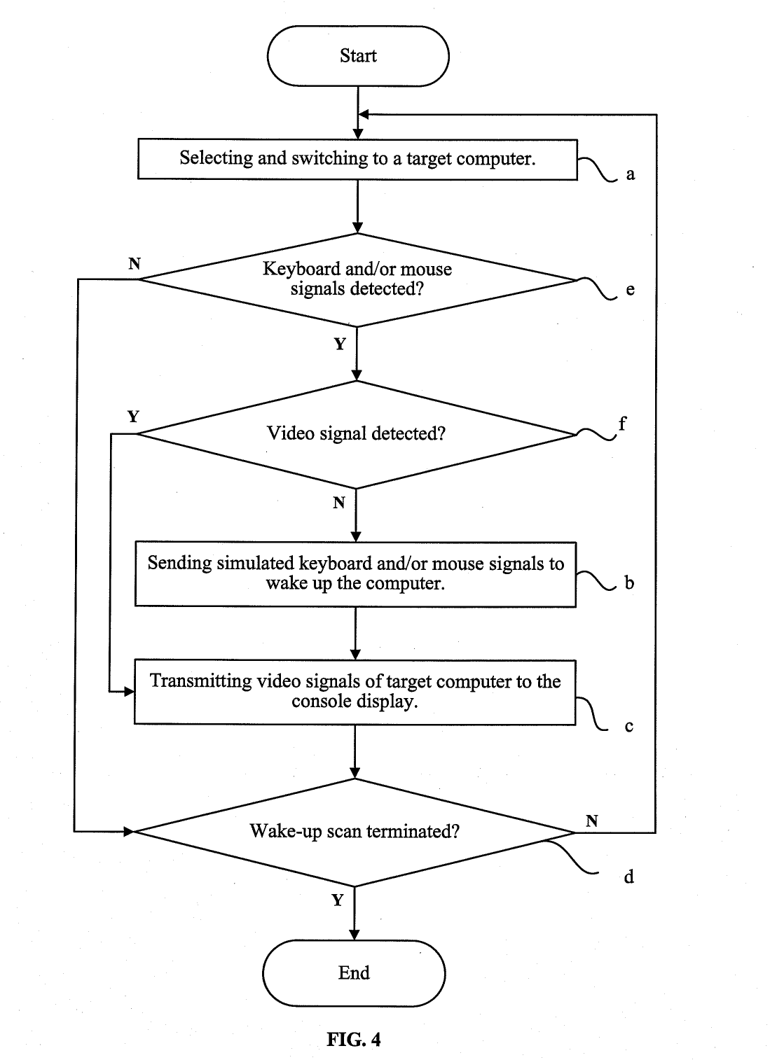

Please refer to FIG. 4, which shows a flow chart of the method of wake-up scan for a keyboard-video-mouse (KVM) switch in accordance with the present invention. The method according to the present invention may be concluded with following steps:

In step (a), selecting and switching to a target computer;

In step (b), sending simulated keyboard and/or mouse signals to the target computer for waking up the target computer;

In step (c), transmitting a video signal of the target computer to at least one console display; and

In step (d), returning to step (a) until a termination command is received. The termination command may be produced under a predetermined condition, such as, exceeding a predetermined period of time for wake-up scanning, exceeding a predetermined number of loops of wake-up scanning, and receiving a termination command from the administrator (user).

In addition, a step (e) may be utilized for skipping null connecting ports, i.e., the ports not connecting to computers or the ports connecting to powered-off computers, after step (a). In step (e), if no computer signals (keyboard and/or mouse signals) of the target computer are detected, jump directly to step (d).

Further more, a step (f) may be utilized for skipping awake computers since no waking up process is needed. In step (f), if the video signal is detected, jump to step (c) for transmitting the video signal of the target computer to the console display for monitoring.

According to the present invention, computers in power saving mode or sleeping mode will be awakened before being scanned. The wake-up scan process according to the present invention makes sure that all real-time images of the power-on computers coupled with the KVM switch can be shown on the console display.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of wake-up scan for a keyboard-video-mouse (KVM) switch capable of monitoring and managing a plurality of computers coupling with a plurality of connecting ports of the KVM switch, the method comprising steps of:
(a) switching to at least one target computer;
(b) sending at least one simulated keyboard signal and/or at least one simulated mouse signal generated by the KVM switch to the target computer for waking up the target computer;
(c) transmitting a video signal of the target computer to at least one console display; and
(d) returning to step (a) until a termination command is received.

2. The method of claim 1, wherein before step (b), further comprises a step of skipping a null connecting port by jumping to step (d) while no computer signals of the target computer are detected, wherein the null connecting port is a disconnected connecting port or a connecting port coupling with a powered-off computer.

3. The method of claim 2, wherein the computer signals comprise an approximately 5-volt DC voltage of a keyboard signal or a mouse signal.

4. The method of claim 1, wherein before step (b), further comprises a step of skipping awakened computers by jumping to step (c) while the video signal of the target computer is detected.

5. The method of claim 4, wherein the video signal is selected from a group consisting of a VGA signal, a DVI signal and a HDMI signal.

6. The method of claim 5, wherein the VGA signal is selected from a group consisting of a R-signal, a G-signal, a B-signal, a H-Sync signal and a V-sync signal.

7. The method of claim 5, wherein the DVI signal or the HDMI signal is an EDID data transmitted in a DDC channel.

8. The method of claim 1, wherein the KVM switch comprises a switching mechanism capable of simultaneously transmitting video signals of a first target computer to a console display and sending the simulated keyboard signal and/or the simulated mouse signal to a second target computer.

9. The method of claim 8, wherein the switching mechanism comprises a first switching device for the video signal and a second switching device for the simulated keyboard signal and the simulated mouse signal.

10. The method of claim 1, wherein the KVM switch comprises a switching mechanism capable of simultaneously transmitting video signals of a first target computer to a console display, checking video signals of a second target computer and sending the simulated keyboard signal and/or the simulated mouse signal to a third target computer.

11. The method of claim 10, wherein the switching mechanism comprises a crosspoint switch.

12. The method of claim 1, wherein the termination command is produced under a predetermined condition selected from a group consisting of exceeding a predetermined period of time for wake-up scanning, exceeding a predetermined number of loops of wake-up scanning and receiving the termination command from a user.

13. The method of claim 1, wherein in step (a), the target computers are switched based on a predetermined order.

14. A keyboard-video-mouse (KVM) switch with wake-up scan function capable of monitoring and managing a plurality of computers via a console, the KVM switch comprising:
a switching mechanism, for switching keyboard, video and mouse signals between the console and the computers;
a keyboard/mouse controller coupling with the switching mechanism, capable of generating at least one simulated keyboard signal and/or at least one simulated mouse signal; and
a micro control unit coupling with the switching mechanism and the keyboard/mouse controller, for detecting computer signals and video signals of the computers, and sending the simulated keyboard and/or mouse signals to the target computer for waking up the computers.

15. The KVM switch of claim 14, wherein the computer signals comprise an approximately 5-volt DC voltage of the keyboard or mouse signals of the computer.

16. The KVM switch of claim 14, wherein the switching mechanism is capable of simultaneously transmitting video signals of a first computer to a console display and sending the simulated keyboard and/or mouse signals to a second computer.

17. The KVM switch of claim 16, wherein the switching mechanism comprises a first switching device for the video signals, and a second switching device for the simulated keyboard and/or mouse signals

18. The KVM switch of claim 14, wherein the switching mechanism is capable of simultaneously transmitting video signals of a first computer to a console display, checking video signals of a second computer and sending the simulated keyboard and/or mouse signals to a third computer.

19. The KVM switch of claim 18, wherein the switching mechanism comprises a crosspoint switch.

20. The KVM switch of claim 14, further comprising a on-screen display circuit coupling with the micro control unit, for setting a predetermined scanning order of the switching mechanism.
